(19) United States
(12) Patent Application Publication
(10) Pub. No.: US 2016/0259758 A1
(43) Pub. Date: Sep. 8, 2016

(54) Digital Camera Simulation Using Spatially Varying PSF Convolutions

(71) Applicants: Animesh Khemka, Fremont, CA (US); Chyuan-Tyng Wu, San Jose, CA (US)

(72) Inventors: Animesh Khemka, Fremont, CA (US); Chyuan-Tyng Wu, San Jose, CA (US)

(21) Appl. No.: 14/637,677

(22) Filed: Mar. 4, 2015

(51) Int. Cl. G06F 17/14

(52) U.S. Cl. CPC G06F 17/14

(57) ABSTRACT

A spatially varying PSF may be applied in a camera simulator by multiplying a fixed weight map by its impact region. Next, Fast Fourier Transform (FFT) both IWₖ and Aₖ, multiply the FFT results element by element and do an inverse FFT (IFFT) to bring the results back to spatial domain. The output image is exactly the same as the outcome of direct approach with the same interpolation method for spatially varying PSF. However, the operation now will be significantly faster in some embodiments.

### BACKGROUND

This relates generally to a camera or optics simulator. A camera simulator is a tool that can simulate the raw image generated by a camera. The outcome of the simulator could be the input data to an image signal processing (ISP) simulator. In addition, the images generated by a camera simulator can also be used as training data for machine learning for imaging algorithm design. The most costly part of a camera (or optics) simulator, is simulating the effect of spatially varying Point Spread Functions (PSFs) of the lens or optics.

A point spread function describes the response of an imaging system to a point source or point object. A point source is a single identifiable source of light having negligible extent and can be modelled mathematically on a point to simplify the analysis. The point spread function may include optical aberrations and diffraction arising in the optics of the camera.

A camera lens or optics causes spatially varying blur which can be modeled as spatially varying PSFs, where the collected light at any location is spread by a specified function. This operation is equivalent to convolution with a spatially varying kernel, precluding the use of traditional speed-up methods like Fast Fourier Transform (FFT) causing the implementation to take an inappropriately long time.

### BRIEF DESCRIPTION OF THE DRAWINGS

Some embodiments are described with respect to the following figures:

FIG. 1 is a schematic depiction of a camera simulator according to one embodiment;

FIG. 2 is a graph showing a PSF at position (x, y);

FIG. 3 is a flow chart for one embodiment;

FIG. 4 is a schematic depiction of an optics simulator for one embodiment;

FIG. 5 is a system depiction for one embodiment; and

FIG. 6 is front elevation of a system according to one embodiment.

### DETAILED DESCRIPTION

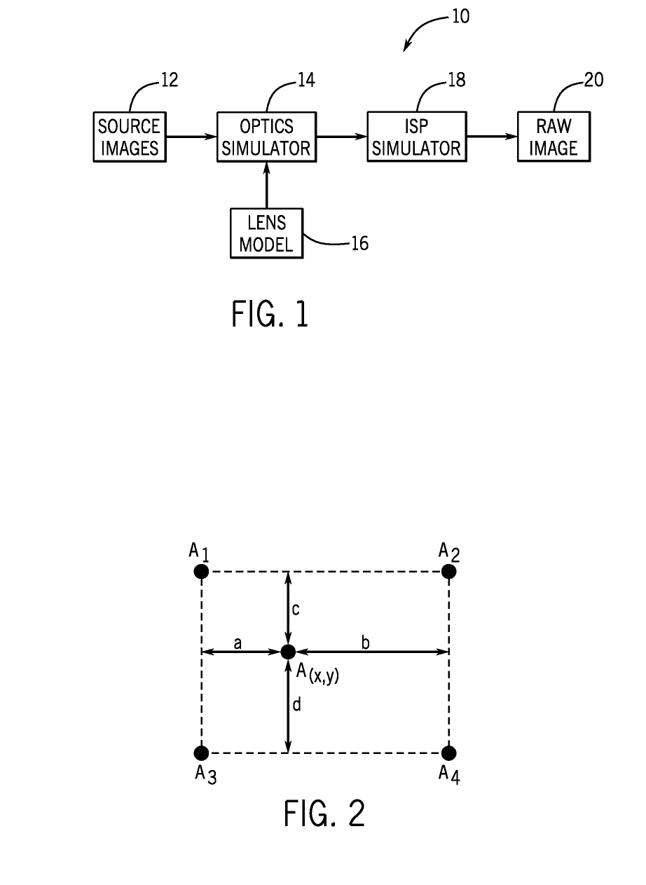

Referring to FIG. 1, a camera simulator 10 may receive source images 12 in the form of digital image files. An optics simulator 14 simulates the effect of a particular optics design using a lens model 16. The lens model 16 may be implemented using PSFs. Then an image signal processing simulator 18 may simulate the other aspects of a conventional digital imaging apparatus such as digital camera. The result is a raw image output 20.

A lens PSF is sampled densely such that bilinear interpolation can be used to estimate the spatially varying PSF at any non-sampled location from the neighboring PSF samples. The effect of spatially varying PSFs can be modelled as the sum of convolutions with fixed PSFs after weighting the input signal with appropriate weights. This allows use of traditional methods like FFT and speeds up the computation by a significant margin in some embodiments. The PSF may be obtained for example from a commercial lens design package.

Assume that a N×N image which is to be convolved with spatially varying m×m PSF. In such a scenario, the traditional methods take O(N² m²) time to perform the convolution. However, for some embodiments the complexity is O(N²·log(N)), and since m² is typically much greater than log(N), there can be substantial time savings in some embodiments.

The first issue is how to measure and estimate the spatially varying PSFs. Assume PSF samples of the lens are measured on a square grid. Then, for each point in the lens, find a square cell which contains this point, and four measured PSF samples which are nearest to it and hence at the corners of the square cell. Now, use bilinear interpolation to estimate the PSF at the targeted location. As long as samples are dense enough, the estimation error will be acceptable. Note that generally the size of the square block is much larger than the size of the PSFs.

In FIG. 2, the PSF at position (x, y), A_{x,y}, is estimated and A₁, A₂, A₃, and A₄ are the corresponding PSF samples at four corners. The boundary case is handled by extending the closest measured samples on the square grid. The distance a, b, c, or d from position (x, y) to each edge is shown. By bilinear interpolation, the PSF at position (x, y) is expressed as following:

$$A ( x , y ) = {\sum }_{k = 1}^{4} {w}_{k} ( x , y ) \cdot {A}_{( x , y ) , k} , \qquad ( 1 )$$

where, wₖ(x, y) is the weight of k₋ₜₕ PSF, k=1, 2, 3, 4, and

$${w}_{1} ( x , y ) = \frac{bd}{( a + b ) ( c + d )} , \\ {w}_{2} ( x , y ) = \frac{ad}{( a + b ) ( c + d )} , \\ {w}_{3} ( x , y ) = \frac{bc}{( a + b ) ( c + d )} , \\ {w}_{4} ( x , y ) = \frac{ac}{( a + b ) ( c + d )}$$

After estimating the PSF at every location, the PSFs are applied to each input pixel. With this direct approach, the intensity of each input image pixel is multiplied by it spatially varying PSF and the computed result is accumulated to generate the final output image. If the resolution of the input image is N×N, the traditional or conventional computation can be presented as:

$$\begin{matrix}{I}_{out} = {\sum }_{x = 1}^{N} {\sum }_{y = 1}^{N} {I}_{in} ( x , y ) \cdot {A}_{( x , y )} \\ = {\sum }_{x = 1}^{N} {\sum }_{y = 1}^{N} {I}_{in} ( x , y ) \cdot [ {\sum }_{k = 1}^{4} {w}_{k} ( x , y ) \cdot {A}_{( x , y ) , k} ] .\end{matrix}$$

For a PSF of size m×m, the total complexity of this traditional method is O(N² m²).

For each pixel in the final output image, one can compute the output by summing locally all the contributions from neighboring pixels. Assume again that the resolution of the input image is N×N and the size of PSF is m×m. Then the intensity of the output image at (x, y) can be computed as following:

$${I}_{out} ( x , y ) = {\sum }_{j = - \frac{m - 1}{2} =}^{\frac{m - 1}{2}} {\sum }_{- \frac{m - 1}{2}}^{\frac{m - 1}{2}} {I}_{in} ( x + i , y + j ) \cdot {A}_{( x + i , y + j )} ( - i , - j ) \qquad ( 2 )$$

Next, substitute the above PSF bilinear-interpolation Equation (1) into Equation (2):

$${I}_{out} ( x , y ) = {\sum }_{j = - \frac{m - 1}{2} =}^{\frac{m - 1}{2}} {\sum }_{- \frac{m - 1}{2}}^{\frac{m - 1}{2}} {I}_{in} ( x + i , y + j ) [ {\sum }_{k = 1}^{4} {w}_{k} ( x + i , y + j ) \cdot {A}_{( x + i , y + j ) , k} ( - i , - j ) ]$$

Rearrange the equation to get:

$${I}_{out} ( x , y ) = {\sum }_{j = - \frac{m - 1}{2} =}^{\frac{m - 1}{2}} {\sum }_{i = \frac{m - 1}{2}}^{\frac{m - 1}{2}} {\sum }_{k = 1}^{4} {I}_{i n} ( x + i , y + j ) \cdot {w}_{k} ( x + i , y + j ) \cdot {A}_{( x + i , y + j ) , k} ( - i , - j )$$

And, let Iᵢₙ (x+i, y+j)·wₖ (x+i, y+j) be written as IWₖ (x+i, y+j), and then the equation can be simplified by following steps:

$$\begin{matrix}{I}_{out} ( x , y ) = {\sum }_{j = - \frac{m - 1}{2} =}^{\frac{m - 1}{2}} {\sum }_{i = \frac{m - 1}{2}}^{\frac{m - 1}{2}} {\sum }_{k = 1}^{4} {IW}_{k} ( x + i , y + j ) \cdot \\ {A}_{( x + i , y + j ) , k} ( - i , - j ) ⇒ {I}_{out} ( x , y ) \\ = {\sum }_{k = 1}^{4} ( {IW}_{k} ⊗ {A}_{( x + i , y + j ) , k} ) ( x , y )\end{matrix}$$

where [symbol] is the convolution operator. Now, considering the whole output image, the final equation is:

$${I}_{out} = {\sum }_{k = 1}^{n} {IW}_{k} ⊗ {A}_{k} \qquad ( 3 )$$

where, n is the total number of PSF samples. The weights wₖ are multiplied pointwise with the image I, so that IWₖ=I·wₖ is the weighted input image for k₋ₜₕ PSF. The product is then convolved with Aₖ to generate the final output. For each PSF sample, only a small portion of pixels in IWₖ will be non-zero, and those non-zero pixels are the impact region of that PSF sample in input image. If PSF samples are spatially uniformly sampled, the values of wₖ in the impact region will be the same for all PSF samples.

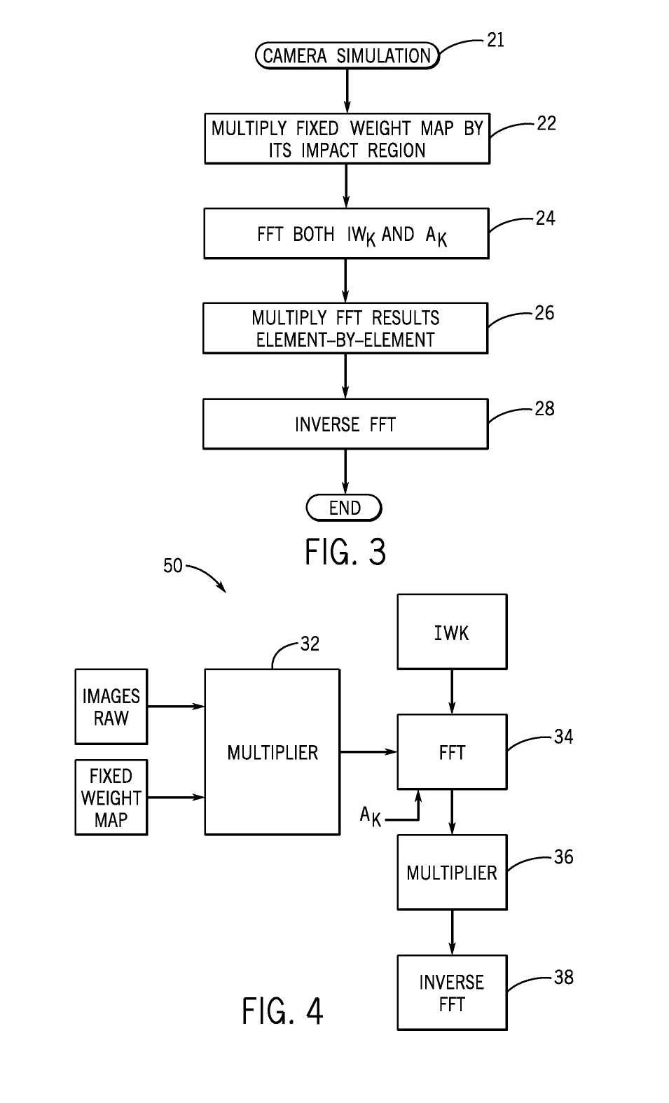

Thus referring to FIG. 3, a sequence 21 may be implemented in software, firmware and/or hardware. In software and firmware embodiments it may be implemented by computer executed instructions stored in one or more non-transitory computer readable media such as magnetic, optical or semiconductor storages.

Hence, to apply the spatially varying PSF, as shown in FIG. 2, first multiply the fixed weight map by its impact region (block 22). In a “fixed” weight map, the weights are independent of the input image I or the PSF kernel Aₖ. The weights are only dependent on the bilinear interpolation and hence if the grid points are the same, then they do not change and are fixed. Next, Fast Fourier Transform (FFT) both IWₖ and Aₖ (block 24) and multiply the FFT results element by element (block 26). “Element by element” multiplication is pointwise multiplication. The operation is performing a convolution in the frequency domain where it is just a pointwise multiplication reducing the total number of operations needed. Then inverse FFT (IFFT) brings the results back to spatial domain (block 28). The output image is exactly the same as the outcome of direct approach with the same interpolation method for spatially varying PSF. However, the operation now will be significantly faster in some embodiments.

In some embodiments, a hardware implementation 50 may be utilized as shown in FIG. 4. For example the hardware implementation may be part of a computer device. The hardware system may include a multiplier 32 that receives as inputs an impact region and fixed weight map. The multiplier multiples these two inputs and provides them to a fast Fourier transform 34. It receives inputs IWₖ and Aₖ. The result of the fast Fourier transform is then multiplied element by element in multiplier 36. Finally the results of the multiplication are subjected to inverse fast Fourier transformer 38.

To analyze the complexity of embodiments of the enhanced algorithm, assume that the image is divided into k×k blocks (each containing N/k×N/k pixels) such that inside any of the blocks, the PSF is computed through bi-linear interpolation as described above. Also, note that generally k is chosen such that N/k>>m and this relation is satisfied for all practical lens systems.

In such a scenario, the enhanced algorithm stipulates that the input image is multiplied by weights w and then the convolution is done with the PSF. This is repeated for the four corner PSFs. Hence, the complexity for each block using the enhanced algorithm is the same as the complexity of doing convolution with FFT 4 times and is:

4[O(N²/k²·log(N²/k²))+O(m² log(m²))+O(N²)]=O(N²/k²·log(N/k))+O(m² log(m)),

Now adding the contributions from all the k×k blocks the total complexity become:

k²O(N²/k²·log(N/k))+k²O(m² log(m))=O(N²·log(N/k))+O(k²m² log(m)).

Now, since N>>km, the complexity reduces to O(N²·log(N/k))=O(N²·log(N)).

The point spread function is a basic characteristic of camera lens. Therefore, to simulate the behavior of camera lens, one would have to apply the PSF. If one assumes the PSF is constant everywhere on lens, the application would not be difficult. However, if one wants to make the simulation more close to reality, one has to simulate spatially varying PSF. To speed up the simulation process, one can use the enhanced algorithm to do the computation.

To simulate a multispectral image in the camera module simulator, the PSF application takes place several times in one simulation. Hence, the application of PSF becomes the most significant time consuming step in the simulation. Using the enhanced algorithm, the computational time to generate the simulated image can be reduced drastically in some embodiments. Thus, it can make the camera simulator tool more useful and user-friendly.

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

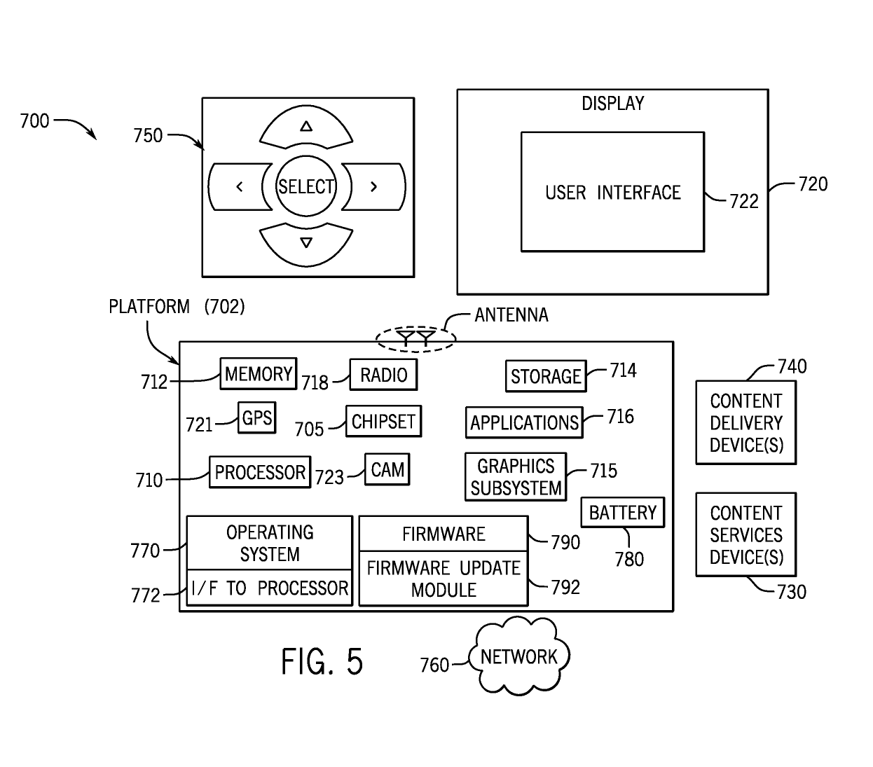

FIG. 5 illustrates an embodiment of a system 700. In embodiments, system 700 may be a media system although system 700 is not limited to this context. For example, system 700 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In embodiments, system 700 comprises a platform 702 coupled to a display 720. Platform 702 may receive content from a content device such as content services device(s) 730 or content delivery device(s) 740 or other similar content sources. A navigation controller 750 comprising one or more navigation features may be used to interact with, for example, platform 702 and/or display 720. Each of these components is described in more detail below.

In embodiments, platform 702 may comprise any combination of a chipset 705, processor 710, memory 712, storage 714, graphics subsystem 715, applications 716 and/or radio 718. Chipset 705 may provide intercommunication among processor 710, memory 712, storage 714, graphics subsystem 715, applications 716 and/or radio 718. For example, chipset 705 may include a storage adapter (not depicted) capable of providing intercommunication with storage 714.

Processor 710 may be implemented as Complex Instruction Set Computer (CISC) or Reduced Instruction Set Computer (RISC) processors, x86 instruction set compatible processors, multi-core, or any other microprocessor or central processing unit (CPU). In embodiments, processor 710 may comprise dual-core processor(s), dual-core mobile processor(s), and so forth. The processor may implement the sequence of FIG. 3 together with memory 712.

Memory 712 may be implemented as a volatile memory device such as, but not limited to, a Random Access Memory (RAM), Dynamic Random Access Memory (DRAM), or Static RAM (SRAM).

Storage 714 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 714 may comprise technology to increase the storage performance enhanced protection for valuable digital media when multiple hard drives are included, for example.

Graphics subsystem 715 may perform processing of images such as still or video for display. Graphics subsystem 715 may be a graphics processing unit (GPU) or a visual processing unit (VPU), for example. An analog or digital interface may be used to communicatively couple graphics subsystem 715 and display 720. For example, the interface may be any of a High-Definition Multimedia Interface, DisplayPort, wireless HDMI, and/or wireless HD compliant techniques. Graphics subsystem 715 could be integrated into processor 710 or chipset 705. Graphics subsystem 715 could be a stand-alone card communicatively coupled to chipset 705.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

Radio 718 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, radio 718 may operate in accordance with one or more applicable standards in any version.

In embodiments, display 720 may comprise any television type monitor or display. Display 720 may comprise, for example, a computer display screen, touch screen display, video monitor, television-like device, and/or a television. Display 720 may be digital and/or analog. In embodiments, display 720 may be a holographic display. Also, display 720 may be a transparent surface that may receive a visual projection. Such projections may convey various forms of information, images, and/or objects. For example, such projections may be a visual overlay for a mobile augmented reality (MAR) application. Under the control of one or more software applications 716, platform 702 may display user interface 722 on display 720.

In embodiments, content services device(s) 730 may be hosted by any national, international and/or independent service and thus accessible to platform 702 via the Internet, for example. Content services device(s) 730 may be coupled to platform 702 and/or to display 720. Platform 702 and/or content services device(s) 730 may be coupled to a network 760 to communicate (e.g., send and/or receive) media information to and from network 760. Content delivery device(s) 740 also may be coupled to platform 702 and/or to display 720.

In embodiments, content services device(s) 730 may comprise a cable television box, personal computer, network, telephone, Internet enabled devices or appliance capable of delivering digital information and/or content, and any other similar device capable of unidirectionally or bidirectionally communicating content between content providers and platform 702 and/display 720, via network 760 or directly. It will be appreciated that the content may be communicated unidirectionally and/or bidirectionally to and from any one of the components in system 700 and a content provider via network 760. Examples of content may include any media information including, for example, video, music, medical and gaming information, and so forth.

Content services device(s) 730 receives content such as cable television programming including media information, digital information, and/or other content. Examples of content providers may include any cable or satellite television or radio or Internet content providers. The provided examples are not meant to limit the applicable embodiments.

In embodiments, platform 702 may receive control signals from navigation controller 750 having one or more navigation features. The navigation features of controller 750 may be used to interact with user interface 722, for example. In embodiments, navigation controller 750 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 750 may be echoed on a display (e.g., display 720) by movements of a pointer, cursor, focus ring, or other visual indicators displayed on the display. For example, under the control of software applications 716, the navigation features located on navigation controller 750 may be mapped to virtual navigation features displayed on user interface 722, for example. In embodiments, controller 750 may not be a separate component but integrated into platform 702 and/or display 720. Embodiments, however, are not limited to the elements or in the context shown or described herein.

In embodiments, drivers (not shown) may comprise technology to enable users to instantly turn on and off platform 702 like a television with the touch of a button after initial boot-up, when enabled, for example. Program logic may allow platform 702 to stream content to media adaptors or other content services device(s) 730 or content delivery device(s) 740 when the platform is turned “off.” In addition, chip set 705 may comprise hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various embodiments, any one or more of the components shown in system 700 may be integrated. For example, platform 702 and content services device(s) 730 may be integrated, or platform 702 and content delivery device(s) 740 may be integrated, or platform 702, content services device(s) 730, and content delivery device(s) 740 may be integrated, for example. In various embodiments, platform 702 and display 720 may be an integrated unit. Display 720 and content service device(s) 730 may be integrated, or display 720 and content delivery device(s) 740 may be integrated, for example. These examples are not meant to be scope limiting.

In various embodiments, system 700 may be implemented as a wireless system, a wired system, or a combination of both. When implemented as a wireless system, system 700 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 700 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 702 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 3.

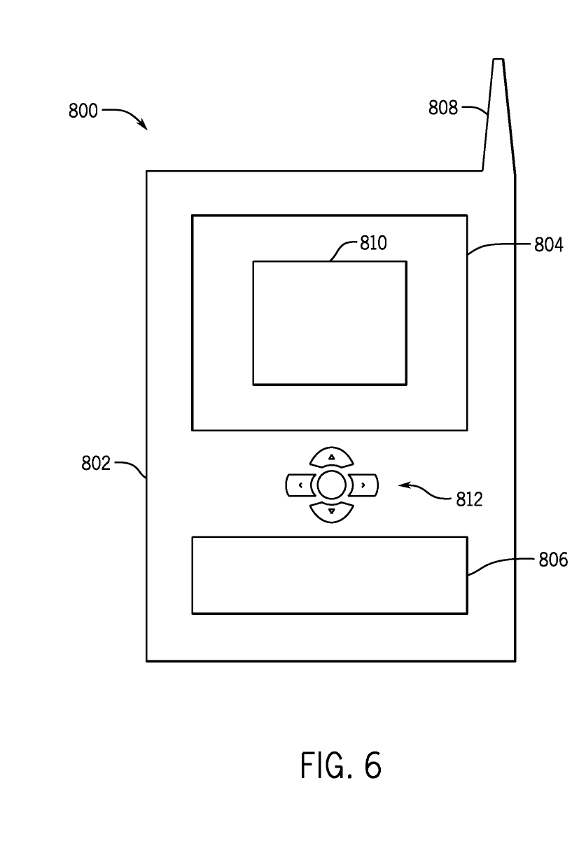

As described above, system 700 may be embodied in varying physical styles or form factors. FIG. 6 illustrates embodiments of a small form factor device 800 in which system 700 may be embodied. In embodiments, for example, device 800 may be implemented as a mobile computing device having wireless capabilities. A mobile computing device may refer to any device having a processing system and a mobile power source or supply, such as one or more batteries, for example.

As shown in FIG. 6, device 800 may comprise a housing 802, a display 804 and 810, an input/output (I/O) device 806, and an antenna 808. Device 800 also may comprise navigation features 812. Display 804 may comprise any suitable display unit for displaying information appropriate for a mobile computing device. I/O device 806 may comprise any suitable I/O device for entering information into a mobile computing device. Examples for I/O device 806 may include an alphanumeric keyboard, a numeric keypad, a touch pad, input keys, buttons, switches, rocker switches, microphones, speakers, voice recognition device and software, and so forth. Information also may be entered into device 800 by way of microphone. Such information may be digitized by a voice recognition device. The embodiments are not limited in this context.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

The following clauses and/or examples pertain to further embodiments:

One example embodiment may be a computer implemented method comprising weighting an input image signal and modelling a spatially varying point spread function of said input signal as a sum of convolutions with fixed point spread functions. The method may also include multiplying a fixed weight by its impact region. The method may also include fast fourier transforming a weighted input image and a point spread function. The method may also include multiplying fast fourier transform results element by element. The method may also include inverse fast fourier transforming to get spatial domain results.

Another example embodiment may be one or more non-transitory computer readable media storing instructions executed by a processor to perform a sequence comprising weighting an input image signal, and modelling a spatially varying point spread function of said input signal as a sum of convolutions with fixed point spread functions. The media may include said sequence including multiplying a fixed weight by its impact region. The media may include said sequence including fast fourier transforming a weighted input image and a point spread function. The media may include said sequence including multiplying fast fourier transform results element by element. The media may include said sequence including inverse fast fourier transforming to get spatial domain results.

In another example embodiment may be an apparatus comprising a device to weight an input image signal, and a unit to model a spatially varying point spread function of said input signal as a sum of convolutions with fixed point spread functions. The apparatus may include a multiplier to multiply a fixed weight by its impact region. The apparatus may include fast fourier transform device to transform a weighted input image and a point spread function. The apparatus may include a multiplier to multiply the fast fourier transform results element by element. The apparatus may include including an inverse fast fourier transform device to provide spatial domain results.

In yet another example embodiment a camera simulator comprising an optics simulator including a multiplier to receive raw images and a fixed weight map and to multiply the fixed weight map by its impact region, a fast fourier transform to receive weights multiplied by an image I and to convolve with a point spread function and an image signal processing simulator coupled to same optics simulator. The simulator may include a multiplier coupled to said transform multiply said transform results element by element. The simulator may include a inverse fast fourier transform to inverse transform the results of said element by element multiplication. The simulator may include a display communicatively coupled to the circuit. The simulator may include a battery coupled to the circuit.

References throughout this specification to “one embodiment” or “an embodiment” mean that a particular feature, structure, or characteristic described in connection with the embodiment is included in at least one implementation encompassed within the present disclosure. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While a limited number of embodiments have been described, those skilled in the art will appreciate numerous modifications and variations therefrom. It is intended that the appended claims cover all such modifications and variations as fall within the true spirit and scope of this disclosure.

What is claimed is:

1. A computer implemented method comprising:
weighting an input image signal; and
modelling a spatially varying point spread function of said input signal as a sum of convolutions with fixed point spread functions.

2. The method of claim 1 including multiplying a fixed weight by its impact region.

3. The method of claim 2 including fast fourier transforming a weighted input image and a point spread function.

4. The method of claim 3 including multiplying fast fourier transform results element by element.

5. The method of claim 4 including inverse fast fourier transforming to get spatial domain results.

6. One or more non-transitory computer readable media storing instructions executed by a processor to perform a sequence comprising:
weighting an input image signal; and
modelling a spatially varying point spread function of said input signal as a sum of convolutions with fixed point spread functions.

7. The media of claim 6, said sequence including multiplying a fixed weight by its impact region.

8. The media of claim 7, said sequence including fast fourier transforming a weighted input image and a point spread function.

9. The media of claim 8, said sequence including multiplying fast fourier transform results element by element.

10. The media of claim 9, said sequence including inverse fast fourier transforming to get spatial domain results.

11. An apparatus comprising:
a device to weight an input image signal; and
a unit to model a spatially varying point spread function of said input signal as a sum of convolutions with fixed point spread functions.

12. The apparatus of claim 11 including a multiplier to multiply a fixed weight by its impact region.

13. The apparatus of claim 12 including fast fourier transform device to transform a weighted input image and a point spread function.

14. The apparatus of claim 13 including a multiplier to multiply the fast fourier transform results element by element.

15. The apparatus of claim 14 including an inverse fast fourier transform device to provide spatial domain results.

16. A camera simulator comprising:
an optics simulator including:
a multiplier to receive raw images and a fixed weight map and to multiply the fixed weight map by its impact region;
a fast fourier transform to receive weights multiplied by an image I and to convolve with a point spread function; and
an image signal processing simulator coupled to same optics simulator.

17. The simulator of claim 16 including a multiplier coupled to said transform multiply said transform results element by element.

18. The simulator of claim 17 including a inverse fast fourier transform to inverse transform the results of said element by element multiplication.

19. The simulator of claim 16 including a display communicatively coupled to the circuit.

20. The simulator of claim 16 including a battery coupled to the circuit.
